(19) United States
(12) Patent Application Publication
(10) Pub. No.: US 2025/0209829 A1
(43) Pub. Date: Jun. 26, 2025

(54) IMAGE PROCESSING DEVICE, IMAGE PROCESSING METHOD, AND STORAGE MEDIUM

(71) Applicant: HONDA MOTOR CO., LTD., Tokyo (JP)

(72) Inventor: Akira Kanehara, Wako-shi (JP)

(21) Appl. No.: 18/999,172

(22) Filed: Dec. 23, 2024

(30) Foreign Application Priority Data
Dec. 25, 2023 (JP) 2023-218574

(51) Int. Cl. G06V 20/56; G06T 5/80; G06T 7/80; G06V 10/44

(52) U.S. Cl. CPC G06V 20/588; G06T 5/80; G06T 7/80; G06V 10/44

(57) ABSTRACT

An image processing device includes: an acquirer configured to acquire a first image obtained by imaging in a first direction and a second image obtained by imaging in a second direction other than the first direction; an extractor configured to extract feature points from the first and the second image acquired; a first and a second detector configured to detect a road area included in the first and second image; a first extractor configured to extract a feature point in the road area detected by the first detector out of the feature points extracted as a first feature point; a second extractor configured to extract a feature point in the road area detected by the second detector out of the feature points extracted as a second feature point; and a calibrator configured to calibrate the first and the second image based on the first and the second feature point.

### CROSS-REFERENCE TO RELATED APPLICATION

Priority is claimed on Japanese Patent Application No. 2023-218574, filed Dec. 25, 2023, the content of which is incorporated herein by reference.

### BACKGROUND

### Field of the Invention

The present invention relates to an image processing device, an image processing method, and a storage medium.

### Description of Related Art

Recently, measures for providing access to a sustainable transportation system in consideration of persons in vulnerable situations out of traffic participants have been actively taken. For the purpose of realization thereof, research and development for improving safety and convenience of traffic through research and development associated with driving assistance technology has been focused on. In this regard, a technique of acquiring a captured image from a camera mounted in a mobile object, extracting feature points from an extracted area which is set or changed on the basis of an external environment of the mobile object in an imaging direction of the camera in the acquired captured image, and estimating a posture of the camera from the extracted feature points is known (for example, Japanese Unexamined Patent Application, First Publication No. 2021-33605). A technique of estimating a road range using feature points appearing in an image captured by another onboard camera other than an onboard camera to be subjected to calibration and performing calibration using only feature points present in the estimated road range out of the feature points appearing in an image captured by the onboard camera to be subjected to calibration is known (for example, Japanese Unexamined Patent Application, First Publication No. 2019-28665).

### SUMMARY

In driving assistance technology, when images obtained by imaging a plurality of directions using imaging devices mounted in a mobile object are processed, there is a problem in that appropriate calibration may not be able to be performed on the images captured by the imaging devices due to factors such as misaligned installation of the imaging devices in the mobile object or unevenness in product performance of the imaging devices.

An objective of the present invention is to solve the aforementioned problem and to provide an image processing device, an image processing method, and a storage medium that can perform more appropriate calibration on an image captured by an imaging device mounted in a mobile object. Another objective of the present invention is to contribute to development of a sustainable transportation system.

An image processing device, an image processing method, and a storage medium according to the present invention employ the following configurations.

(1) An image processing device according to an aspect of the present invention is an image processing device including: an acquirer configured to acquire a first image obtained by imaging in a first direction of a mobile object and a second image obtained by imaging in a second direction other than the first direction from an imaging device mounted in the mobile object; an extractor configured to extract feature points from the first image and the second image acquired by the acquirer; a first detector configured to detect a road area included in the first image; a second detector configured to detect a road area included in the second image; a first feature point extractor configured to extract a feature point in the road area detected by the first detector out of the feature points extracted by the extractor as a first feature point; a second feature point extractor configured to extract a feature point in the road area detected by the second detector out of the feature points extracted by the extractor as a second feature point; and a calibrator configured to calibrate the first image and the second image on the basis of the first feature point and the second feature point.

(2) In the aspect of (1), the imaging device includes a first imager configured to capture the first image and a second imager configured to capture the second image, and the calibrator derives a relative angle between the first imager and the second imager on the basis of a result of calibration of the first image and the second image.

(3) In the aspect of (1), the calibrator calibrates the first image and the second image when each of the first feature point extractor and the second feature point extractor has extracted a feature point included in the road area successively in a predetermined number of frames or more.

(4) In the aspect of (2), the calibrator derives the relative angle on the basis of a normal vector of a road surface of the road area included in the first image and a normal vector of a road surface in the road area included in the second image, converts a coordinate system of the second image to a coordinate system of the first image on the basis of the derived relative angle, and calibrates the first image and the second image.

(5) In the aspect of (3), the first feature point extractor extracts a feature point in a first road area in which the mobile object moves and a feature point in a second road area which crosses the first road area as the first feature point from image frames of the first image which are acquired at predetermined time intervals by the acquirer, the second feature point extractor extracts a feature point in the first road area and a feature point in the second road area as the second feature point from image frames of the second image which are acquired at predetermined time intervals by the acquirer, and the calibrator calibrates the first image and the second image when the first feature point and the second feature point are extracted from the first image and the second image successively in a predetermined number of frames or more.

(6) In the aspect of (1), the road area includes a first road area in which the mobile object moves and a second road area which crosses the first road area.

(7) In the aspect of (6), the calibrator calibrates pitch angles of the first imager that captures the first image and the second imager that captures the second image on the basis of the feature point in the first road area, and the calibrator calibrates roll angles of the first imager and the second imager on the basis of the feature point in the second road area.

(8) An image processing method according to another aspect of the present invention is an image processing method that is performed by a computer, the image processing method including: acquiring a first image obtained by imaging in a first direction of a mobile object and a second image obtained by imaging in a second direction other than the first direction from an imaging device mounted in the mobile object; extracting feature points from the acquired first image and the acquired second image; detecting a road area included in the first image; detecting a road area included in the second image; extracting a feature point in the detected road area included in the first image out of the extracted feature points as a first feature point; extracting a feature point in the detected road area included in the second image out of the extracted feature points as a second feature point; and calibrating the first image and the second image on the basis of the first feature point and the second feature point.

(9) A storage medium according to another aspect of the present invention is a non-transitory computer-readable storage medium that stores a program causing a computer to perform: acquiring a first image obtained by imaging in a first direction of a mobile object and a second image obtained by imaging in a second direction other than the first direction from an imaging device mounted in the mobile object; extracting feature points from the acquired first image and the acquired second image; detecting a road area included in the first image; detecting a road area included in the second image; extracting a feature point in the detected road area included in the first image out of the extracted feature points as a first feature point; extracting a feature point in the detected road area included in the second image out of the extracted feature points as a second feature point; and calibrating the first image and the second image on the basis of the first feature point and the second feature point.

According to the aspects of (1) to (9), it is possible to perform more appropriate calibration on an image captured by an imaging device mounted in a mobile object.

### BRIEF DESCRIPTION OF THE DRAWINGS

FIG. 1 is a diagram illustrating an example of a functional configuration of a driving assistance device including an image processing device according to an embodiment.

FIG. 2 is a diagram illustrating installation positions and imaging directions of cameras of an imaging device with respect to a vehicle.

FIG. 3 is a diagram illustrating an example of a forward-view image captured by a forward-view camera and a backward-view image captured by a first backward-view camera.

FIG. 4 is a diagram illustrating an example of a backward-view image captured by a second backward-view camera.

FIG. 5 is a flowchart illustrating an example of a process flow based on a first calibration pattern.

FIG. 6 is a flowchart illustrating an example of a process flow based on a second calibration pattern.

FIG. 7 is a diagram illustrating a coordinate conversion process according to the embodiment.

### DESCRIPTION OF EMBODIMENTS

Hereinafter, an image processing device, an image processing method, and a storage medium according to an embodiment of the present invention will be described with reference to the accompanying drawings. In the following embodiment, an image processing device that is mounted in a mobile object will be described. A mobile object includes a vehicle with three wheels or four wheels, a vehicle with two wheels, and a micromobility and includes all mobile objects which a person (an occupant such as a driver) may board. The mobile object may include a driving assistance device that assists driving of an occupant (a driver) of the mobile object on the basis of images processed by the image processing device. In the following description, it is assumed that the mobile object is a vehicle with four wheels (hereinafter referred to as a “vehicle M”) and includes a driving assistance device. The vehicle M may be one of an automobile with an internal combustion engine such as a diesel engine or a gasoline engine as a power source, an electric vehicle with an electric motor as a power source, and a hybrid vehicle with an internal combustion engine and an electric motor. In the following description, a forward direction of the vehicle M is defined as a plus X direction, a backward direction of the vehicle M is defined as a minus X direction, a width direction of the vehicle M which is a rightward direction with respect to the plus X direction is defined as a plus Y direction, a leftward direction is defined as a minus Y direction, and a direction which is perpendicular to the X direction and the Y direction and which is a height direction of the vehicle M is defined as a plus Z direction.

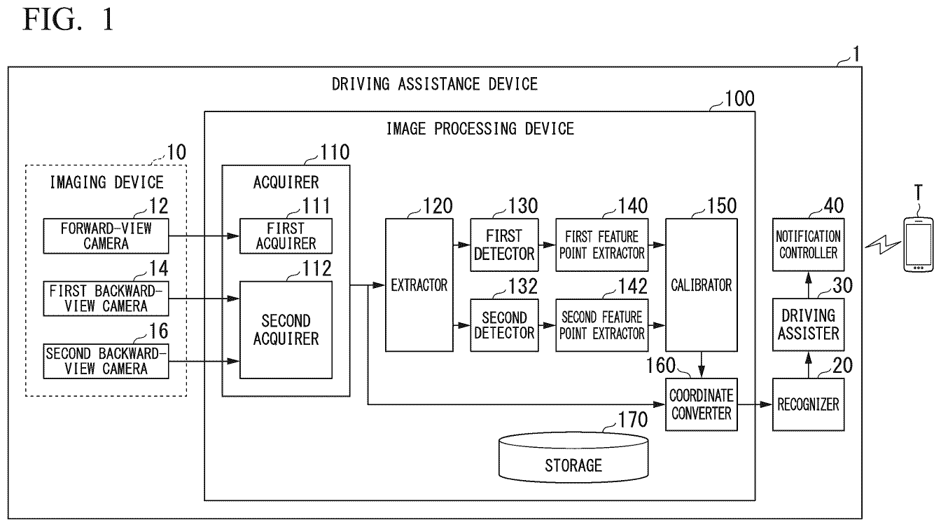

FIG. 1 is a diagram illustrating an example of a functional configuration of a driving assistance device 1 including an image processing device according to the embodiment. The driving assistance device 1 illustrated in FIG. 1 includes, for example, an imaging device 10, a recognizer 20, a driving assister 30, a notification controller 40, and an image processing device 100. The recognizer 20, the driving assister 30, the notification controller 40, and the image processing device 100 are realized, for example, by causing a hardware processor such as a central processing unit (CPU) to execute a program (software). Some or all of these constituents may be realized by hardware (a circuit unit including circuitry) such as a large scale integration (LSI) circuit, an application-specific integrated circuit (ASIC), a field-programmable gate array (FPGA), a graphics processing unit (GPU), or a system-on-chip (SOC) or may be cooperatively realized by software and hardware. The program may be stored in a storage device (a storage device including a non-transitory storage medium) such as a hard disk drive (HDD) or a flash memory in advance or may be stored in a detachable storage medium (a non-transitory storage medium) such as a DVD or a CD-ROM and installed by setting the storage medium into a drive device. The vehicle M according to the embodiment includes constituents for allowing the vehicle M to travel (for example, a driving operator, a drive device such as an engine and a motor, a steering device, a brake device, and various vehicle sensors (for example, a position sensor or a speed sensor)) and various types of onboard devices such as a navigation device, a display device, and a speaker for performing route guidance or the like in addition to the configuration of the driving assistance device 1 illustrated in FIG. 1.

The imaging device 10 images the surroundings of the vehicle M. For example, the imaging device 10 is, for example, a digital camera using a solid-state imaging device such as a charge-coupled device (CCD) or a complementary metal oxide semiconductor (CMOS). The imaging device 10 may be a stereo camera. The imaging device 10 may be, for example, a camera that is used in a drive recorder or the like. In the example illustrated in FIG. 1, the imaging device 10 includes a forward-view camera 12, a first backward-view camera 14, and a second backward-view camera 16 as a plurality of imagers. The forward-view camera 12 is an example of a “first imager.” At least one of the first backward-view camera 14 and the second backward-view camera 16 is an example of a “second imager.”

The forward-view camera 12 images a predetermined area in front of the vehicle M. The first backward-view camera 14 and the second backward-view camera 16 image a predetermined area in a direction (for example, a backward direction of the vehicle M) other than the forward direction. The forward direction is an example of a “first direction,” and the backward direction is an example of a “second direction.” An area in a lateral direction (a side direction) of the vehicle M may be included in at least one of a forward-view image (an example of a first image) captured by the forward-view camera 12 and a backward-view image (an example of a second image) captured by the first backward-view camera 14 or the second backward-view camera 16.

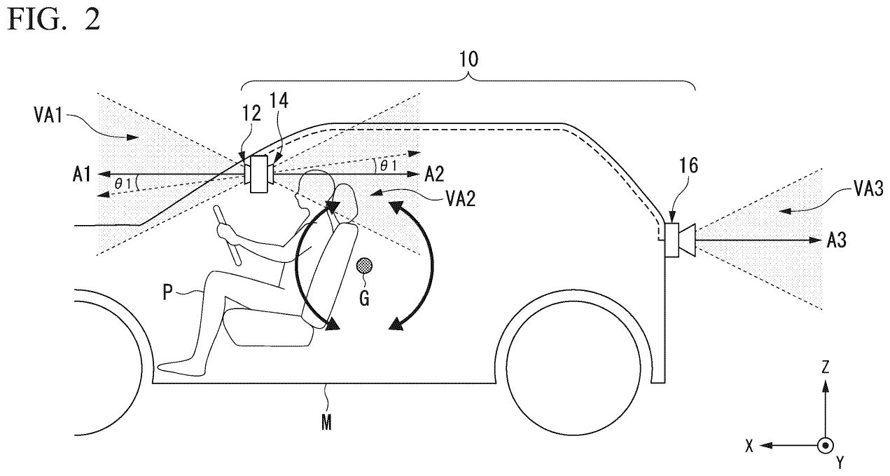

FIG. 2 is a diagram illustrating installation positions and imaging directions of cameras of the imaging device 10 with respect to the vehicle M. The forward-view camera 12 and the first backward-view camera 14 of the imaging device 10 are installed, for example, in the vicinity of an upper part of a front windshield on the front side of the vehicle M as illustrated in FIG. 2. In the example illustrated in FIG. 2, the forward-view camera 12 and the first backward-view camera 14 are constituted as a unified body within a predetermined distance. Constitution as a unified body may include, for example, a configuration in which the forward-view camera 12 and the first backward-view camera 14 are housed in a single housing or are connected (coupled) to each other. In this configuration, for example, when the forward-view camera 12 images a predetermined viewing-angle area VA1 centered on a forward direction A1 (the plus X-axis direction in the drawing) of the vehicle M, the first backward-view camera 14 images a predetermined viewing-angle area VA2 including a cabin centered on a reverse direction A2 of the forward direction A1 of the vehicle M. Accordingly, when the forward-view camera 12 images a viewing-angle area centered on a direction tilted downward by an angle θ1 with respect to the forward direction A1 of the vehicle M due to misalignment based on a certain factor at the time of or after installation, the first backward-view camera 14 images a viewing-angle area centered on a direction tilted upward by the angle θ1 with respect to the reverse direction A2 of the forward direction A1. That is, in the embodiment, when misalignment occurs in an imaging direction (a viewing angle) of one of the forward-view camera 12 and the first backward-view camera 14 which are constituted as a unified body, the same misalignment in a direction symmetric with respect to the installation position of the imaging device 10 occurs in the imaging direction (the viewing angle) of the other camera.

In the example illustrated in FIG. 2, the second backward-view camera 16 is installed on the rear side of the vehicle body (outside of the vehicle body), but may be installed on the rear side of the cabin. The second backward-view camera 16 is installed at a position interposing the center in a pitch rotational direction (for example, the center of gravity) G of the vehicle M along with the installation position of the forward-view camera 12. The second backward-view camera 16 images a predetermined viewing-angle area VA3 centered on a reverse direction A3 (the same direction as the direction A2) of the forward direction A1 of the vehicle M. The second backward-view camera 16 can image an outside situation of the vehicle (a road shape) or the like in a broader range than that of the first backward-view camera 14 because it images the viewing-angle area VA3 not including the cabin.

The second backward-view camera 16 may be electrically connected to the forward-view camera 12 or the first backward-view camera 14, for example, via a cable or may be connected via a frame member. In the embodiment, it is assumed that the forward-view camera 12 (and the first backward-view camera 14) and the second backward-view camera 16 are separate. Accordingly, the imaging directions of the cameras may have a difference not associated with each other due to misalignment based on a certain factor at the time of installation or after installation or unevenness in product performance.

The imaging device 10 is not limited to the configuration illustrated in FIG. 2 and may include, for example, a plurality of imagers for imaging an area in front of the vehicle M or one or three or more imagers for imaging an area behind the vehicle M. The imaging device 10 may include a side camera for imaging in a lateral direction (a side) of the vehicle M in addition to the forward-view camera 12, the first backward-view camera 14, and the second backward-view camera 16. The imaging device 10 may include a fish-eye camera that can image the surroundings including a forward area and a backward area of the vehicle M in a wide angle (for example, 360 degrees) instead of the aforementioned camera configuration. An image captured by the fish-eye camera may be divided into a plurality of images (a forward-view image, a backward-view image, and a side-view image) according to the imaging direction. The imaging device 10 repeatedly performs imaging using the cameras in a predetermined period and outputs the captured images (camera images) to the image processing device 100.

Referring back to FIG. 1, the image processing device 100 acquires images captured by the imaging device 10 and performs a process of converting a coordinate system of the images (hereinafter referred to as a camera coordinate system) to a coordinate system other than the camera coordinate system. The camera coordinate system includes a forward-view camera coordinate system corresponding to the forward-view image and a backward-view camera coordinate system corresponding to the backward-view image. The coordinate system other the camera coordinate system is, for example, a coordinate system (a bird's-eye view coordinate system) centered on the position of the vehicle M when seen from above the vehicle M. An image converted into the bird's-eye view coordinate system is used for the recognizer 20 to recognize the surrounding situation of the vehicle M and to notify (display to) an occupant (such as a driver) of the vehicle M.

The image processing device 100 includes, for example, an acquirer 110, an extractor 120, a first detector 130, a second detector 132, a first feature point extractor 140, a second feature point extractor 142, a calibrator 150, a coordinate converter 160, and a storage 170.

The storage 170 may be realized by a storage device such as an HDD or a flash memory, a solid state drive (SSD), an electrically erasable programmable read only memory (EEPROM), a read only memory (ROM), a random access memory (RAM), or the like. The storage 170 stores, for example, images acquired by the acquirer 110, process results from the calibrator 150 or the coordinate converter 160, programs, and various types of other information. Map information may be stored in the storage 170. The map information is, for example, information in which road shapes are expressed in correlation with position information (latitude and longitude information) using links indicating roads and nodes connected by the links. The map information may include information of curvatures or gradients, the number of lanes, widths, and lane centers of roads or lane boundary information such as road markings for defining lanes. The map information may include traffic regulation information, position information including branching, merging, crossings, and a T-shaped road, facility information such as buildings or parking lots, and point of interest (POI) information. The map information may be updated from time to time by causing the vehicle M or the driving assistance device 1 to communicate with other devices.

The acquirer 110 acquires camera images which are captured in a predetermined period by the imaging device 10. The acquirer 110 includes, for example, a first acquirer 111 and a second acquirer 112. The first acquirer 111 acquires a forward-view image captured by the forward-view camera 12 (an example of a first image obtained by imaging in a first direction of a mobile object). The second acquirer 112 acquires a backward-view image captured by at least one of the first backward-view camera 14 and the second backward-view camera 16 (an example of a second image obtained by imaging in a second direction different from the first direction).

The extractor 120 extracts feature points included in the forward-view image and the backward-view image acquired by the acquirer 110. For example, the extractor 120 performs an existing image analysis process such as an edge extracting process on the forward-view image and the backward-view image and extracts feature points of objects in a real space (which includes, for example, traffic signals, road markings, traffic participants such as pedestrians or other vehicles, buildings, road areas, lane markings, and stop lines) which are included in an image on the basis of results of the image analysis process. In this case, for example, the extractor 120 extracts a sequence of points on an edge of an object included in an image as feature points (a feature point group). The extractor 120 may extract feature points using a trained model which has been trained to output an edge of an object (for example, a building or a road structure) appearing in an image as a point group when a forward-view image or a backward-view image is input thereto. This trained model may be stored in the storage 170 in advance or may be acquired from an external device via a communication device (not illustrated) mounted in the vehicle M. The extractor 120 may extract feature points, for example, using a technique of visual simultaneous localization and mapping (SLAM) which is a technique of three-dimensionally ascertaining a self-position from image data obtained by the imaging device 10. The technique of extracting feature points on an image is not limited to the aforementioned example, and another existing technique may be used.

In the extractor 120, a first extractor for extracting feature points in a forward-view image and a second extractor for extracting feature points in a backward-view image may be provided separately, and, furthermore, an extractor for extracting feature points from a backward-view image captured by the first backward-view camera 14 and an extractor for extracting feature points from a backward-view image captured by the second backward-view camera 16 may be provided as separate constituents.

The first detector 130 detects a road area included in the forward-view image. The second detector 132 detects a road area included in the backward-view image. The road area includes, for example, a traveling lane area (hereinafter referred to as a “host-vehicle road area”) in which the vehicle M travels (moves) and an area of a lane (hereinafter referred to as a “crossing road area”) which crosses the host-vehicle road area. The host-vehicle road area may include a neighboring lane or an oncoming lane extending in the same direction in addition to the traveling lane of the vehicle M. The crossing road area is, for example, a road which is connected to the host-vehicle road area in a predetermined angle range including a right angle in a crossing or a T-shaped road. The host-vehicle road area is an example of a “first road area.” The crossing road area is an example of a “second road area.”

The first feature point extractor 140 extracts a feature point in the road area detected by the first detector 130 out of the feature points (the feature point group) extracted by the extractor 120 as a first feature point. The second feature point extractor 142 extracts a feature point in the road area detected by the second detector 132 out of the feature points (the feature point group) extracted by the extractor 120 as a second feature point. The first feature point and the second feature point are used to calibrate images (calibration) in the embodiment.

The calibrator 150 calibrates the camera images (the forward-view image and the backward-view image) captured by the imaging device 10 on the basis of the first feature point extracted by the first feature point extractor 140 and the second feature point extracted by the second feature point extractor 142. For example, when the coordinate system of the camera images (the camera coordinate system) is misaligned from a reference coordinate system due to misalignment at the time of installation of the imaging device 10, vibration after installation, misalignment based on a contact with an occupant or the like, unevenness in camera performance, and the like (an amount of misalignment is equal to or greater than a threshold value), the calibrator 150 calibrates three-dimensional axes of the camera coordinate system to match the reference coordinate system (the amount of misalignment becomes less than the threshold value). The reference coordinate system is, for example, a coordinate system based on the posture of the vehicle M (a vehicle coordinate system), and calibration of camera images is to calibrate the camera coordinate system of the first image and the second image with the vehicle coordinate system. Calibration of an image may be replaced with calibration of postures of the cameras in the imaging device 10. For example, the calibrator 150 calibrates at least one of a pitch direction (for example, a tilt in the longitudinal direction of each camera of the imaging device 10), a roll direction (a tilt in the lateral direction of each camera), and a yaw direction (tilt in a rotational direction of each camera when seen from above) such that the three-dimensional vehicle coordinate system based on the vehicle M and the three-dimensional camera coordinate system match each other. The calibrator 150 may derive image-calibration parameters (for example, information on at least one of a pitch angle, a roll angle, and a yaw angle).

The coordinate converter 160 converts the coordinate system (the camera coordinate system) of an image acquired by the acquirer 110 to the bird's-eye view coordinate system which is an example of a different coordinate system. In this case, the coordinate converter 160 may perform coordinate conversion on an image calibrated by the calibrator 150 using coordinate-conversion parameters serving as a reference stored in the storage 170 or the like in advance or may perform coordinate conversion including calibration on an image acquired by the acquirer 110 on the basis of the reference coordinate-conversion parameters and the aforementioned image-calibration parameters. Accordingly, it is possible to perform more accurate image conversion.

The recognizer 20 recognizes the surrounding situations of the vehicle M on the basis of an image (hereinafter referred to as a “bird's-eye view image”) converted into the bird's-eye view coordinate system by the coordinate converter 160. For example, the recognizer 20 recognizes an object near the vehicle M (within a predetermined distance from the vehicle M) on the basis of the bird's-eye view image. For recognition of an object, for example, an object recognition technique using a model based on deep learning, deep machine learning, or the like, an object recognition technique using pattern matching, or an object recognition technique in which such object recognition techniques are combined is performed. The recognizer 20 may recognize an object near the vehicle M with reference to the map information stored in the storage 170 on the basis of position information of the vehicle M which is acquired by a position sensor such as a global position system (GPS) device included in a vehicle sensor.

Here, examples of an object include traffic participants such as other vehicles or pedestrians, lane boundaries (road boundaries) including road markings, road shoulders, curbstones, median strips, and guardrails, stop lines, obstacles, traffic signals, road signs, toll gates, and bridges. Examples of an object may include ground objects such as buildings or street trees near the vehicle M. Traffic participants such as other vehicles or pedestrians out of the objects are recognized on the basis of a bird's-eye view image, and the other objects are recognized on the basis of one or both of the bird's-eye view image and the map information. The recognizer 20 may recognize types, shapes, sizes, and the like of various types of objects or recognize a position (a relative position to the vehicle M), a speed (a relative speed to the vehicle M), and the like of each object.

The driving assister 30 performs driving assistance for an occupant (a driver or the like) of the vehicle M on the basis of the result of recognition from the recognizer 20. For example, the driving assister 30 determines whether the vehicle M departs from the traveling lane of the vehicle M (for example, the host-vehicle road area) defined by the road markings recognized by the recognizer 20 and notifies the driver of the vehicle M via the notification controller 40 when there is a likelihood of departure or controls steering of the vehicle M via a steering device (not illustrated) such that departure of the vehicle M from the traveling lane is curbed (such that the vehicle M moves to the central side of the traveling lane). The driving assister 30 recognizes an obstacle such as another vehicle near the vehicle M (within a predetermined distance from the vehicle M) and notifies the occupant via the notification controller 40 or performs traveling control (at least one of speed control and steering control) for avoiding contact therewith when it is determined that there is a likelihood of contact with the obstacle on the basis of the relative position or the relative speed with respect to the obstacle.

The notification controller 40 notifies the occupant (driver) of the vehicle M in association with driving assistance under the control of the driving assister 30. In this case, the notification controller 40 generates notification information such as sound (alarm) or an image correlated with notification details which the occupant is to be notified of and transmits the generated notification information to a terminal device T to output the notification information.

Here, the terminal device T is, for example, a portable terminal device such as a smartphone or tablet terminal which is used by the driver of the vehicle M in which the driving assistance device 1 is mounted. In the terminal device T, for example, an application or the like for receiving driving assistance from the driving assistance device 1 is being executed. The application receives information transmitted from the driving assistance device 1 and displays an image based on the notification on a display of the terminal device T or outputs sound from a speaker of the terminal device T. The terminal device T is an example of a “notifier.” For example, the terminal device T is detachably attached to the vehicle M and is used. For example, a holder for the terminal device T including an attachment/detachment part is provided in one or both of the terminal device T and the vehicle M, and the terminal device T is assisted by the holder. In the embodiment, when devices (notifier) such as a navigation device, a display device, and a speaker are mound in the vehicle M, notification information may be output from the mounted devices instead of (or in addition to) the terminal device T on the basis of an instruction from the driving assister 30.

### [Forward-View Image and Backward-View Image]

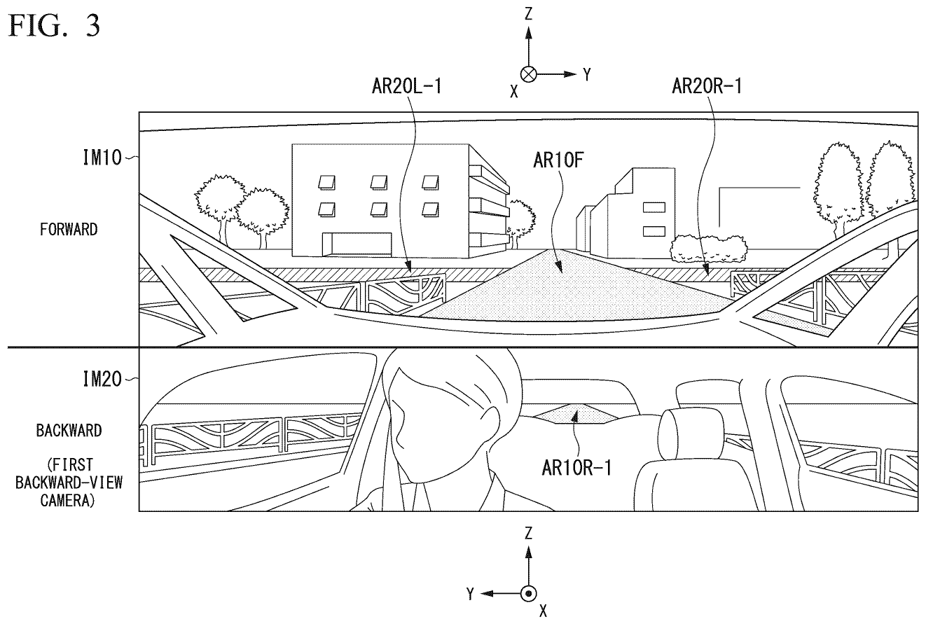

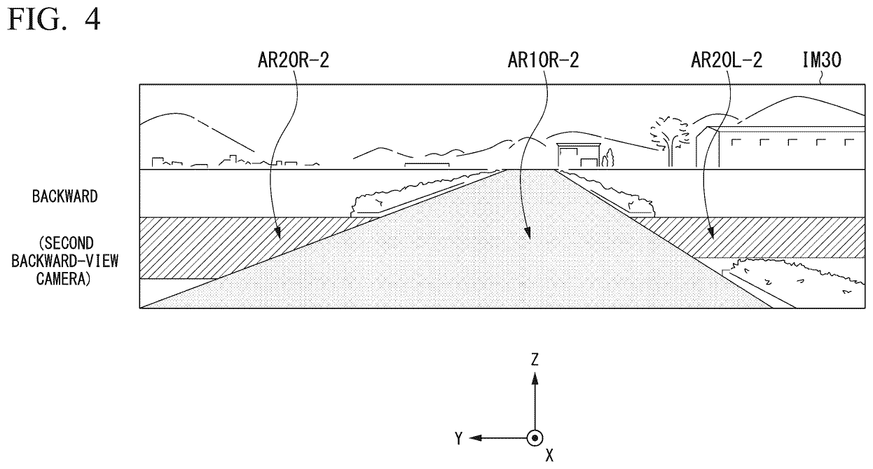

Examples of the forward-view image and the backward-view image in the embodiment will be described below with reference to the drawings. FIG. 3 is a diagram illustrating an example of a forward-view image IM10 captured by the forward-view camera 12 and a backward-view image IM20 captured by the first backward-view camera 14. In the forward-view image IM10, an area of the vehicle outside (the front side of the vehicle M) is imaged over the front windshield of the vehicle M. In the backward-view image IM20, a rear area including the cabin is imaged, and an area of the vehicle outside (the lateral side or the rear side of the vehicle M) is imaged over a side windshield and a rear windshield. FIG. 4 is a diagram illustrating an example of a backward-view image IM30 which is captured by the second backward-view camera 16. In the backward-view image IM30, an area of the vehicle outside (the rear side of the vehicle M) is imaged over the rear windshield of the vehicle M. The image processing device 100 calibrates these images and performs recognition of a nearby object using the calibrated images, and the like.

### [Image Calibration]

An image calibrating process according to the embodiment will be specifically described below divisionally in some calibration patterns. In the following description, for the purpose of convenience of explanation, the backward-view image IM30 captured by the second backward-view camera 16 is used as a backward-view image, but the backward-view image IM20 captured by the first backward-view camera 14 may be used instead of (or in addition to) the backward-view image IM30 or a side image obtained by imaging the side of the vehicle M may be used.

### [First Calibration Pattern]

In a first calibration pattern, a forward-view image and a backward-view image are calibrated, and then a relative angle between the forward-view camera 12 and the second backward-view camera 16 (a relative angle between the forward-view image and the backward-view image) is derived on the basis of the result of calibration. Then, the coordinate system of one image (for example, the backward-view image) is converted to the coordinate system of the other image (for example, the forward-view image) on the basis of the derived relative angle, both images are combined, and calibration is additionally performed on the combined image.

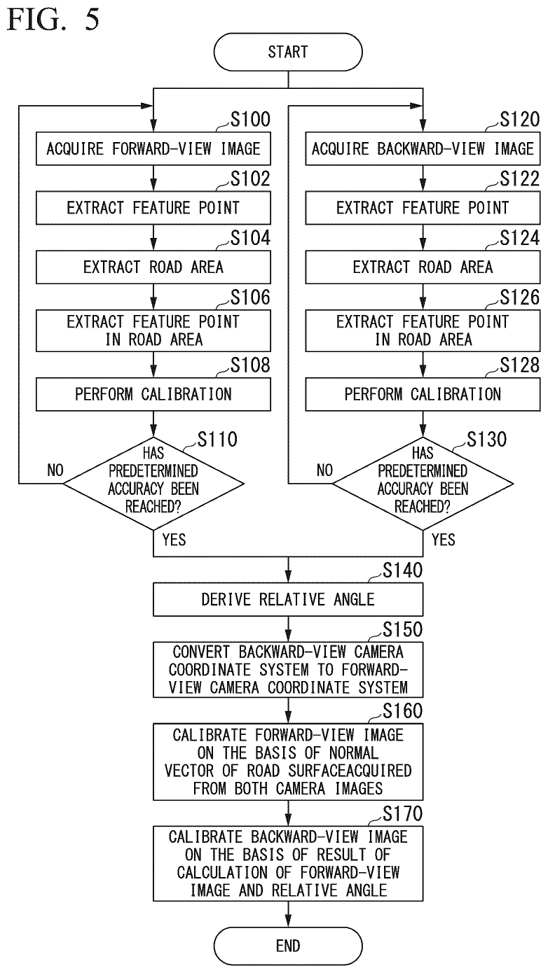

FIG. 5 is a flowchart illustrating an example of a process in the first calibration pattern. In the example illustrated in FIG. 5, the first acquirer 111 acquires a forward-view image IM10 captured by the forward-view camera 12 (Step S100). Then, the extractor 120 extracts feature points of the forward-view image IM10 (Step S102). Then, the first detector 130 detects a road area included in the forward-view image IM10 (Step S104).

The process of Step S104 will be specifically described below. The first detector 130 detects a host-vehicle road area and a crossing road area included in the forward-view image IM10. For example, the first detector 130 acquires point sequence parts (feature point groups arranged within a predetermined distance in the same direction (which includes an allowable error range)) on the right and left sides of the vehicle M included in the feature point group extracted by the extractor 120 as road markings and detects an area defined by the acquired road markings as a host-vehicle road area. For example, the first detector 130 may divide the forward-view image IM10 into a plurality of sub areas and detect the host-vehicle road area for each sub area. As illustrated in the forward-view image IM10 or the backward-view image IM20 illustrated in FIG. 3, a position at which the host-vehicle road area is present in each image is close to the center of the image and can be easily predicted to a certain extent. Accordingly, the first detector 130 may detect the host-vehicle road area based on the feature point groups from a partial area (for example, a predetermined area including the center of the image) in which there is predicted to be a high likelihood that the host-vehicle road area will be present in the forward-view image IM10 in advance. Accordingly, it is possible to decrease a process load associated with detection of the host-vehicle road area.

The first detector 130 detects point sequence parts connected to the detected host-vehicle road area at a predetermined angle, and sets two point sequences as road markings and detects an area defined by the road markings as a crossing road area when the two point sequences are in parallel (which includes an allowable error range) within a predetermined distance. The predetermined angle is, for example, a predetermined angle range (for example, from about 75 degrees to about 105 degrees) including 90 degrees (a right angle) with respect to an extending direction of the host-vehicle road area. The first detector 130 may detect a crossing road area based on the feature point groups from a sub area in which the likelihood that the crossing road area will be present is predicted to be high in the forward-view image IM10 in advance.

The first detector 130 may be realized, for example, using a function based on artificial intelligence (AI) and a function based on a previously given model in parallel. For example, the function of detecting a host-vehicle road area and a crossing road area may be realized by performing detection of the host-vehicle road area and the crossing road area based on deep learning or the like and detection thereof based on a previously given determination process (for example, a determination process based on pattern matching) in parallel on the forward-view image IM10, scoring both detection results, and comprehensively evaluating the scores.

When a specific road structure such as a traffic signal or a walk crossing is detected from the forward-view image IM10, the first detector 130 may perform a process of detecting a crossing road area within a predetermined distance from a position at which the road structure has been detected. When it is determined that the position of the vehicle M is close to (within a predetermined distance from) a position at which there is a high likelihood that a road crossing such as a crossing point or a T-shaped road will be present with reference to the map information stored in the storage 170 on the basis of the position information of the vehicle M, the first detector 130 may perform the process of detecting a crossing road area. The position information of the vehicle M may be acquired, for example, by a position sensor mounted in the vehicle M. Accordingly, since the detection process is performed on an area in which there is a high likelihood that a crossing road area will be present, it is possible to more efficiently detect a crossing road area. In the example illustrated in FIG. 3, the first detector 130 detects a host-vehicle road area AR10F in front of the vehicle M from the forward-view image IM10 and detects crossing road areas AR20L-1 and AR20R-1.

Then, the first feature point extractor 140 extracts feature points of the detected road area out of the feature points in the forward-view image IM10 (Step S106). Specifically, the first feature point extractor 140 extracts feature points included in the host-vehicle road area AR10F and the crossing road areas AR20L-1 and AR20R-1 detected by the first detector 130 out of the feature points (feature point groups) extracted by the extractor 120.

Then, the calibrator 150 calibrates the forward-view image IM10 on the basis of the extracted feature points in the road area (Step S108). For example, the calibrator 150 estimates least square planes for the feature point groups included in the host-vehicle road area AR10F and the crossing road areas AR20L-1 and AR20R-1 as road surfaces. Then, the calibrator 150 calibrates the forward-view image such that the camera coordinate system based on the estimated road surface matches the vehicle coordinate system based on the posture of the vehicle M (an amount of misalignment therebetween is less than a threshold value) (in other words, the estimated road surface matches the road surface with respect to the posture of the vehicle M). At this time, the calibrator 150 may derive an amount of misalignment from the vehicle coordinate system or may derive image-calibration parameters.

Then, the calibrator 150 determines whether calibration accuracy has reached predetermined accuracy (Step S110). In the process of Step S110, the calibrator 150 determines that calibration accuracy has reached predetermined accuracy when the amount of misalignment between the estimated road surface and the road surface based on the posture of the vehicle M is less than a threshold value successively in a predetermined number of frames or longer and determines that calibration accuracy has not reached predetermined accuracy otherwise. When it is determined that calibration accuracy has not reached predetermined accuracy, the process flow returns to Step S100, and the process flow is repeatedly performed until it is determined for a next image frame that calibration accuracy has reached predetermined accuracy. When the next image frame is processed, the process may be performed after the image has been calibrated using the image-calibration parameters derived in the process of Step S108 in advance.

The image processing device 100 performs the processes of Steps S120 to S130 described below in parallel with (or at timings before and after) the processes of Steps S100 to S110. Specifically, first, the second acquirer 112 acquires a backward-view image IM30 captured by the second backward-view camera 16 (Step S120). Then, the extractor 120 extracts feature points of the backward-view image IM30 (Step S122). Then, the second detector 132 detects a road area (a host-vehicle road area or a crossing road area) included in the backward-view image IM30, for example, using the same method as in the first detector 130 (Step S124). The second detector 132 detects a host-vehicle road area AR10R-1 behind the vehicle M from the backward-view image IM20 in the example illustrated in FIG. 3 and detects a host-vehicle road area AR10R-2 and crossing road areas AR20L-2 and AR20R-2 behind the vehicle M from the backward-view image IM30 in the example illustrated in FIG. 4.

Then, the second feature point extractor 142 extracts feature points in the road areas (the host-vehicle road area AR10R-1 and AR10R-2 and the crossing road areas AR20L-2 and AR20R-2) out of the feature points in the backward-view image IM30 (Step S126). Then, the calibrator 150 calibrates the backward-view image IM30 on the basis of the extracted feature points in the road areas (Step S128). Then, the calibrator 150 determines whether calibration accuracy has reached predetermined accuracy (Step S130). When it is determined that calibration accuracy has not reached predetermined accuracy, the process flow returns to Step S120, and the process flow is repeatedly performed until it is determined that calibration accuracy has reached predetermined accuracy. In the processes of Steps S128 and S130, the calibrator 150 performs the same processes as in Steps S108 and S110 on the feature points in the road areas (the host-vehicle road area AR10R-1 and AR10R-2 and the crossing road areas AR20L-2 and AR20R-2).

When it is determined in the processes of Steps S110 and S130 that calibration accuracy in both the forward-view image IM10 and the backward-view image IM30 has reached predetermined accuracy, the calibrator 150 derives a relative angle between the forward-view camera 12 and the second backward-view camera 16 (that is, a relative angle in the coordinate system between the forward-view image IM10 and the backward-view image IM30) from the calibrated images (Step S140). For example, the calibrator 150 calculates the relative angle of the backward-view image IM30 with respect to the forward-view image IM10 (an amount of misalignment between the coordinate systems) on the basis of the image-calibration parameters for the forward-view image IM10 and the image-calibration parameters for the backward-view image IM30. Since the forward-view image IM10 and the backward-view image IM30 are different in imaging direction, the calibrator 150 derives the relative angle by adjusting the directions of the coordinate system, for example, on the basis of a reference coordinate system based on a posture of the same object such as the vehicle M.

Then, the calibrator 150 converts the camera coordinate system of the second backward-view camera 16 (a backward-view camera coordinate system) to the camera coordinate system (a forward-view camera coordinate system) of the forward-view camera 12 (the forward-view image IM10) on the basis of the relative angle (Step S150). Then, the calibrator 150 calibrates the forward-view image IM10 on the basis of normal vectors of road surfaces of the road areas acquired from both the camera images (Step S160). For example, the calibrator 150 derives normal vectors of the road surfaces in the road areas (the host-vehicle road area and the crossing road area) included in the forward-view image IM10 and the backward-view image IM30. The normal vector may be derived for each image or may be divisionally derived in the host-vehicle road area and the crossing road area. When a plurality of normal vectors are derived, the normal vectors may be averaged or the normal vector in a road area with higher priority may be derived. Then, the calibrator 150 calibrates the forward-view image IM10 (that is, the posture of the forward-view camera 12) such that the derived normal vector matches the normal vector of the road surface based on the posture of the vehicle M. In this case, the calibrator 150 may derive the image-calibration parameters.

In the process of Step S160, the calibrator 150 may perform calibration in the pitch direction (the pitch angle) of the forward-view image IM10 (the forward-view camera 12) using the normal vector of the road surface in the host-vehicle road area and perform calibration in the roll direction (the roll angle) using the normal vector of the road surface in the crossing road area. Since the host-vehicle road area is an area extending in a vertical direction of the image (the longitudinal direction of the vehicle M) and the crossing road area is an area extending in a horizontal direction of the image (the lateral direction of the vehicle M), it is possible to perform more appropriate calibration in each direction by performing calibration in the pitch direction of the vehicle M (or the imaging device 10) using the host-vehicle road area and performing calibration in the roll direction of the vehicle M (or the imaging device 10) using the crossing road area.

Then, the calibrator 150 calibrates the backward-view image IM30 (that is, the posture of the second backward-view camera 16) on the basis of the calibration result (the image-calibration parameters) of the forward-view image IM10 and the relative angle. As a result, the process flow in the flowchart ends.

With the process based on the first calibration pattern, it is possible to improve calibration accuracy of the images by performing a calibration process on the forward-view image and the backward-view image, then deriving the relative angle between both the camera images, converting the coordinate system of one image to the coordinate system of the other image on the basis of the derived relative angle, and then performing calibration, and thus it is possible to acquire information of more road areas from both the images. Accordingly, it is possible to perform a calibration process with higher accuracy. With the process based on the first calibration pattern, even when there are factors such as installation misalignment among a plurality of cameras which are installed in the vehicle M or unevenness in product performance of the imaging devices, it is possible to more appropriately calibrate images captured by the imaging devices.

### [Second Calibration Pattern]

In a second calibration pattern, feature points in road areas included in the forward-view image IM10 and the backward-view image IM30 are extracted, and then calibration of the forward-view image IM10 and the backward-view image IM30 is performed collectively using the feature points.

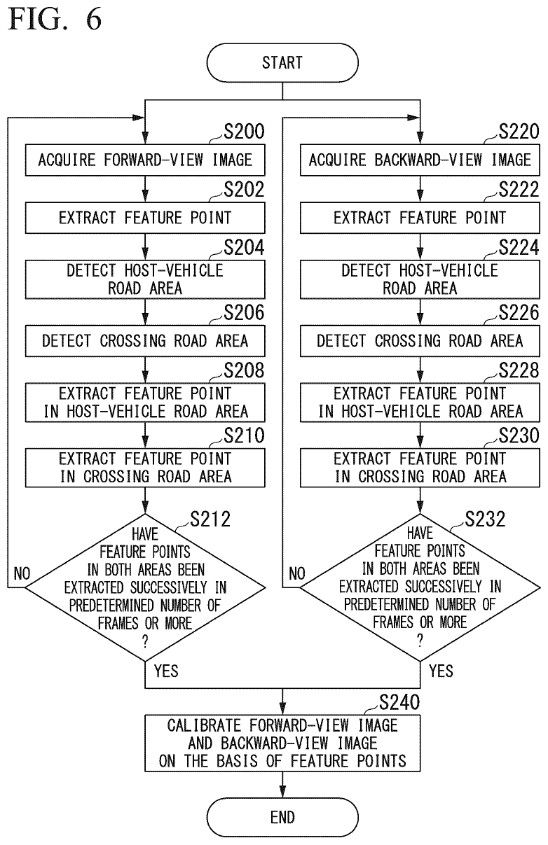

FIG. 6 is a flowchart illustrating an example of a process in the second calibration pattern. In the example illustrated in FIG. 6, the first acquirer 111 acquires a forward-view image IM10 (an image frame) captured by the forward-view camera 12 (Step S200). Then, the extractor 120 extracts feature points of the forward-view image IM10 (Step S202). Then, the first detector 130 detects a host-vehicle road area included in the forward-view image IM10 (Step S204) and detects a crossing road area with respect to the host-vehicle road area (Step S206). For example, the same method as the detection method in the first calibration pattern can be used as the method of detecting the host-vehicle road area and the crossing road area. Then, the first feature point extractor 140 extracts feature points in the host-vehicle road area out of the feature points in the forward-view image IM10 (Step S208) and extracts feature points in the crossing road area (Step S210).

The, the calibrator 150 determines whether feature points in both the host-vehicle road area and the crossing road area have been extracted successively in a predetermined number of frames or more (Step S212). When it is determined that the feature points in both the host-vehicle road area and the crossing road area have not been extracted successively in a predetermined number of frames or more, the process flow returns to Step S200, and the process flow is repeatedly performed until it is determined that the feature points in both the host-vehicle road area and the crossing road area have been extracted successively in the predetermined number of frames or more.

The image processing device 100 performs the processes of Steps S220 to S232 described below in parallel with (or at timings before and after) the processes of Steps S200 to S212. Specifically, first, the second acquirer 112 acquires a backward-view image IM30 captured by the second backward-view camera 16 (Step S220). The, the extractor 120 extracts feature points in the backward-view image IM30 (Step S222). Then, the second detector 132 detects a host-vehicle road area included in the backward-view image IM30 (Step S224) and detects a crossing road area with respect to the host-vehicle road area (Step S226). Then, out of the feature points of the backward-view image IM30, the second feature point extractor 142 extracts feature points in the host-vehicle road area (Step S228) and extracts feature points in the crossing road area (Step S230). Then, the calibrator 150 determines whether feature points in both the host-vehicle road area and the crossing road area have been extracted successively in a predetermined number of frames or more (Step S232). When it is determined that feature points in both the areas have not been extracted successively in a predetermined number of frames or more, the process flow returns to Step S220, and the process flow is repeatedly preformed until it is determined that feature points in both the areas have been extracted successively in a predetermined number of frames or more.

When it is determined in the processes of Step S212 and S232 that feature points in both the host-vehicle road area and the crossing road area have been extracted from the forward-view image IM10 and the backward-view image IM30, the calibrator 150 calibrates the forward-view image and the backward-view image using the extracted feature points (Step S240).

The process of Step S240 will be specifically described below. For example, the calibrator 150 performs an optical flow process of detecting a motion of a feature point between frames and expressing the detected motion as a vector (a motion vector) on the basis of changes in position of the feature points with the elapse of time of host-vehicle road area AR10F, AR10R-1, and AR10R-2 (hereinafter roughly referred to as a “host-vehicle road area AR10”) and crossing road areas AR20L-1, AR20R-1, AR20L-2, and AR20R-2 (hereinafter roughly referred to as a “crossing road area AR20”) which are included in two image frames with a time difference for each of the forward-view image IM10 and the backward-view image IM20. The motion vector includes, for example, information on a moving direction and an amount of movement (an amount of displacement). A time interval (a period of time) between two different image frames in which the motion vector is acquired may be a period (an integer multiple of the period) of the image frames acquired by the acquirer 110 or may be set to be variable on the basis of the speed of the vehicle M or sizes of the road areas (the host-vehicle road area and the crossing road area).

As the feature points used in the optical flow process, thinned-out feature points of which the number is equal to or less than a predetermined number may be used instead of using all the feature points included in the host-vehicle road area AR10 and the crossing road area AR20. In this case, the calibrator 150 may divide the host-vehicle road area AR10 and the crossing road area AR20 into a plurality of sub areas and perform adjustment such that the number of feature points for each sub area is equal to or greater than a lower limit and equal to or less than an upper limit. It is possible to decrease a process load by decreasing the number of feature points used in the optical flow process.

The calibrator 150 sets a normal vector in a direction perpendicular to the road surface of each of the host-vehicle road area AR10 and the crossing road area AR20 on the basis of the motion vector acquired through the optical flow process and the traveling direction of the vehicle M in a period of time between two different image frames. For example, the calibrator 150 extracts a plurality of motion vectors from the road area, sets a road surface (a plane) of a host-vehicle road or a crossing road on the basis of directions of the plurality of extracted motion vectors (directions corresponding to the traveling direction of the vehicle M), and derives a normal vector of the set road surface. The calibrator 150 may derive the normal vector separately in the host-vehicle road area or the crossing road area acquired from each of the forward-view image IM10 and the backward-view image IM30.

Then, the calibrator 150 performs calibration such that an amount of misalignment between the derived normal vector and a normal vector with respect to the road surface based on the posture of the vehicle M (a reference normal vector) is equal to or less than a threshold value. When there are a plurality of normal vectors, the calibrator 150 may perform calibration through comparison between an average normal vector obtained by averaging the normal vectors and the reference normal vector or may perform calibration such that an error (a least square error) between the plurality of normal vectors and the reference normal vector is equal to or less than a threshold value.

In the embodiment, since the forward-view camera 12 and the second backward-view camera 16 are separately configured, the amounts of misalignment therein are different. Accordingly, the calibrator 150 performs calibration such that the normal vector derived from the forward-view image IM10 and the normal vector derived from the backward-view image IM30 separately match the reference normal vector. The calibrator 150 may derive the relative angle between the forward-view image and the backward-view image (the forward-view camera 12 and the second backward-view camera 16) on the basis of two image-calibration parameters acquired through the calibration.

Similarly to the first calibration pattern, the calibrator 150 may calibrate the pitch direction (the pitch angle) of the forward-view image IM10 (the forward-view camera 12) using the normal vector of the road surface in the host-vehicle road area and calibrate the roll direction (the roll angle) using the normal vector of the road surface in the crossing road area. Accordingly, it is possible to perform more appropriate calibration in the pitch direction and the roll direction.

With the process using the second calibration pattern, since calibration is performed using information on the feature points of the road areas acquired from the forward-view image and the backward-view image, it is possible to perform a calibration process with higher accuracy. With the process using the second calibration pattern, even when there are factors such as installation misalignment of a plurality of cameras installed in the vehicle M or unevenness in product of the imaging devices, it is possible to perform more appropriate calibration on the images captured by the imaging devices.

### [Coordinate Converter and Recognizer]

Processes in the coordinate converter 160 and the recognizer 20 according to the embodiment will be described below. For example, the coordinate converter 160 converts the camera coordinate system of an image acquired by the acquirer 110 to a bird's-eye view coordinate system. In this case, the coordinate converter 160 may add image-calibration parameters (calibration parameters in the pitch direction and the roll direction) to predetermined reference coordinate-conversion parameters and then perform coordinate conversion, or may perform a coordinate converting process on an image calibrated by the calibrator 150.

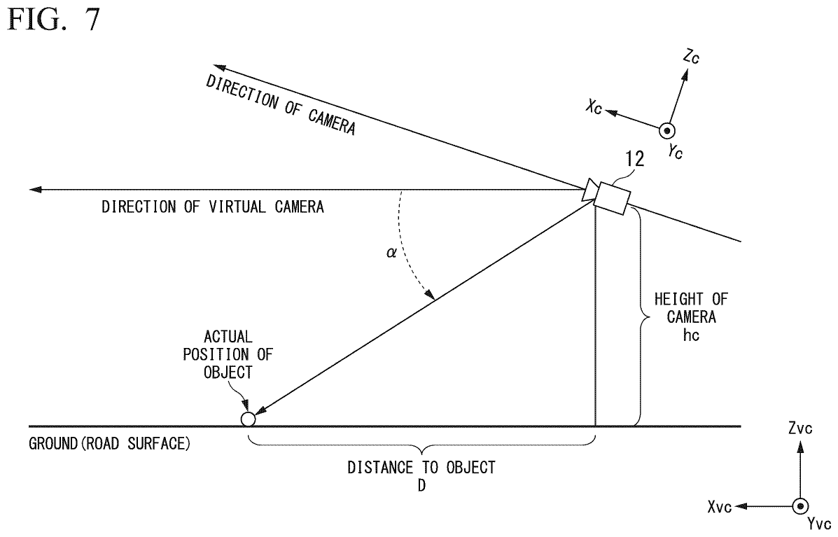

FIG. 7 is a diagram illustrating a coordinate converting process according to the embodiment. For example, axes of the camera coordinate system (three dimensions) of an image captured by the imaging device 10 (the forward-view camera 12 in the example illustrated in FIG. 7) are defined as [Xc, Yc, Zc], and a virtual camera coordinate system (a vehicle coordinate system) which is based on the posture of the vehicle M and which is parallel to the ground surface (a movement road surface) in the traveling direction of the vehicle M are defined as [Xvc, Yvc, Zvc]. Here, Xvc denotes the traveling direction of the vehicle M, Yvc denotes the lateral direction of the vehicle M, and Zvc denotes the vertical direction of the vehicle M. When the roll angle of the vehicle M is defined as θ, the pitch angle is defined as ρ, and the yaw angle is defined as ϕ, the angles [θ, ρ, ϕ] represent rotation angles around the axes of the virtual camera coordinate system [Xvc, Yvc, Zvc]. Here, the roll angle θ and the pitch angle ρ may have values which are calibrated by the calibrator 150. The calibrator 150 converts (rotates) the camera coordinate system to the virtual camera coordinate system which is parallel to the ground surface in the traveling direction, for example, using Expression (1).

$$\begin{matrix}[ Equation 1 ] & \\ [ \begin{matrix}{X}_{vc} \\ {Y}_{v c} \\ {Z}_{vc}\end{matrix} ] = {R}_{Z} {R}_{Y} {R}_{X} [ \begin{matrix}{X}_{c} \\ {Y}_{c} \\ {Z}_{c}\end{matrix} ] & ( 1 )\end{matrix}$$

Degrees of freedom in rotation Rx, Ry, Rz about the axes in Expression (1) are derived using Expressions (2) to (4).

$$\begin{matrix}[ Equation 2 ] & \\ {R}_{x} = [ \begin{matrix}1 & 0 & 0 \\ 0 & cos θ & - s in θ \\ 0 & sin θ & cos θ\end{matrix} ] & ( 2 )\end{matrix}$$

$${R}_{y} = [ \begin{matrix}cos ρ & 0 & sin ρ \\ 0 & 1 & 0 \\ - sin ρ & 0 & cos ρ\end{matrix} ] \qquad ( 3 )$$

$${R}_{z} = [ \begin{matrix}cos ϕ & - sin ϕ & 0 \\ sin ϕ & cos ϕ & 0 \\ 0 & 0 & 1\end{matrix} ] \qquad ( 4 )$$

The recognizer 20 recognizes the surrounding situations such as a position of an object near the vehicle M using the images processed by the image processing device 100. For example, the recognizer 20 recognizes a position of an object when an image in the calibrated camera coordinate system is converted into the bird's-eye view coordinate system.

For example, when the ground surface (the road surface) is normally flat (angle fluctuations are allowable) as illustrated in FIG. 7, the recognizer 20 recognizes an azimuth angle and a distance in the bird's-eye view coordinate system of an object in the camera coordinate system seen from the forward-view camera 12. In this case, for example, the recognizer 20 calculates a depression angle α (a look-down angle of an object when it is expressed in a polar coordinate system based on a direction of a virtual camera) using Expression (5) and calculates the azimuth angle β using “β=tan⁻¹(Yvc/Xvc).”

$$\begin{matrix}[ Equation 3 ] & \\ α = {cos}^{- 1} \frac{{Z}_{v c}}{\sqrt{{X}_{vc}^{2} + {Y}_{vc}^{2} + {Z}_{v c}^{2}}} & ( 5 )\end{matrix}$$

When an installation position (a height hc) of the forward-view camera 12 is set in advance, the recognizer 20 calculates a distance D from the vehicle M (more specifically the position of the forward-view camera 12 mounted in the vehicle M) to an object using the depression angle α and the height hc through “D=hc/tan α.” The recognizer 20 can more appropriately recognize a position of an object near the vehicle M in the bird's-eye view coordinate system or a distance to the object by performing these processes on the object near the vehicle M.

The notification controller 40 may generate an image indicating the surrounding situation of the vehicle M converted into the bird's-eye view coordinate system and notify an occupant of the generated image via the terminal device T as well as notify the occupant of information on driving assistance. Accordingly, it is possible to display the accurate surrounding situation to the occupant in a display mode which the occupant can look easily.

### Modified Examples

Instead of extracting feature points in all the images and extracting feature points of a host-vehicle road area and a crossing road area out of the extracted feature points as described above in the embodiment, a host-vehicle road area and a crossing road area included in an image may be first extracted and feature points included in the extracted road areas may be extracted.

In the embodiment, the calibrator 150 may calibrate an image when a host-vehicle road area or a crossing road area with a predetermined area or more is extracted from the forward-view image or the backward-view image. Accordingly, since a normal vector of a road surface can be more accurately acquired in a road area with a relatively large area, it is possible to perform more appropriate calibration.

In the embodiment, the image processing device 100 may set priorities of the forward-view camera 12, the first backward-view camera 14, and the second backward-view camera 16 and preferentially calibrate the camera with a set higher priority. For example, when there is a camera in which misalignment is likely to occur according to an installation position or the like, it is possible to curb deterioration of recognition accuracy using an image after performing the calibration process prior to the other cameras. In the embodiment, the image processing device 100 may perform a correction process such as aberration correction of distortion correction on the forward-view camera 12, the first backward-view camera 14, and the second backward-view camera 16. In the embodiment, an image (a side-view image) including the lateral direction of the vehicle M may be used instead of (or in addition to) the backward-view image.

One of the first calibration pattern and the second calibration pattern may be combined with a part or whole of the other. The image processing device 100 may perform a predetermined one of the first calibration pattern and the second calibration pattern or may perform both and combine (average) results thereof. The calibrator 150 may selectively perform one calibration pattern according to the traveling situation of the vehicle M (the nearby road conditions) or the detection situation of a road area. For example, when a detected road area is equal to or larger than a predetermined area, feature points of the road area can be detected even if a forward-view image and a backward-view image are separately acquired, and thus the calibration process is performed using the first calibration pattern. When the detected road area is smaller than the predetermined area, the number of feature points in the road area is small, and thus the calibration process is performed using the second calibration pattern in which calibration is performed using the feature points of both the forward-view image and the backward-view image. Accordingly, it is possible to perform a more appropriate calibration process according to situations.

According to the aforementioned embodiment, the image processing device 100 includes: the acquirer 110 configured to acquire a first image obtained by imaging in a first direction of a mobile object and a second image obtained by imaging in a second direction other than the first direction from the imaging device 10 mounted in the mobile vehicle M (an example of a mobile object); the extractor 120 configured to extract feature points from the first image and the second image acquired by the acquirer 110; the first detector 130 configured to detect a road area included in the first image; the second detector 132 configured to detect a road area included in the second image; the first feature point extractor 140 configured to extract a feature point in the road area detected by the first detector 130 out of the feature points extracted by the extractor 120 as a first feature point; the second feature point extractor 142 configured to extract a feature point in the road area detected by the second detector 132 out of the feature points extracted by the extractor 120 as a second feature point; and the calibrator 150 configured to calibrate the first image and the second image on the basis of the first feature point and the second feature point. Accordingly, it is possible to perform more appropriate calibration on an image captured by the imaging device 10 mounted in the vehicle M.

Specifically, according to the embodiment, since calibration of an image is performed on the basis of feature points in the host-vehicle road area and the crossing road area, for example, using a forward-view image and a backward-view image of the vehicle M, it is possible to perform more accurate calibration using a larger amount of information. Particularly, the crossing road area can be easily acquired additionally using the backward-view image. According to the embodiment, regarding the pitch direction of the vehicle M (the imaging device 10), it is possible to perform more accurate calibration in the pitch direction by using feature points in the host-vehicle road area extending in the longitudinal direction of the vehicle M. Regarding the roll direction of the vehicle M (the imaging device 10), it is possible to perform more accurate calibration in the roll direction by using information (a normal vector on the road surface of a crossing road) acquired from the crossing road area extending in the lateral direction of the vehicle M.

According to the embodiment, even when there are factors such as misaligned installation of imaging devices in a vehicle M or unevenness in product performance of the imaging devices, it is possible to perform more appropriate conversion of coordinates of an image by performing calibration using a forward-view image and a backward-view image captured by the imaging devices mounted in the vehicle M. According to the embodiment, for example, even when a forward-view camera and a backward-view camera are installed with a pitch rotation center of the vehicle M interposed therebetween or when imaging ranges do not overlap each other because the cameras are installed at separate positions, it is possible to perform appropriate calibration in both the roll direction and the pitch direction. Accordingly, it is possible to more accurately recognize a relative position or a relative distance between the vehicle M and a nearby object using calibrated images and to realize more appropriate driving assistance through such recognition.

The aforementioned embodiment can be expressed as follows:

An image processing device including:
a storage medium storing computer-readable instructions; and
a processor connected to the storage medium,
wherein the processor executes the computer-readable instructions to perform:
   acquiring a first image obtained by imaging in a first direction of a mobile object and a second image obtained by imaging in a second direction other than the first direction from an imaging device mounted in the mobile object;
   extracting feature points from the acquired first image and the acquired second image;
   detecting a road area included in the first image;
   detecting a road area included in the second image;
   extracting a feature point in the detected road area included in the first image out of the extracted feature points as a first feature point;
   extracting a feature point in the detected road area included in the second image out of the extracted feature points as a second feature point; and
   calibrating the first image and the second image on the basis of the first feature point and the second feature point.

While an embodiment of the present invention has been described above, the present invention is not limited to the embodiment and can be subjected to various modifications and substitutions without departing from the gist of the present invention.

What is claimed is:

1. An image processing device comprising:
an acquirer configured to acquire a first image obtained by imaging in a first direction of a mobile object and a second image obtained by imaging in a second direction other than the first direction from an imaging device mounted in the mobile object;
an extractor configured to extract feature points from the first image and the second image acquired by the acquirer;
a first detector configured to detect a road area included in the first image;
a second detector configured to detect a road area included in the second image;
a first feature point extractor configured to extract a feature point in the road area detected by the first detector out of the feature points extracted by the extractor as a first feature point;
a second feature point extractor configured to extract a feature point in the road area detected by the second detector out of the feature points extracted by the extractor as a second feature point; and
a calibrator configured to calibrate the first image and the second image on the basis of the first feature point and the second feature point.

2. The image processing device according to claim 1, wherein the imaging device includes a first imager configured to capture the first image and a second imager configured to capture the second image, and
wherein the calibrator derives a relative angle between the first imager and the second imager on the basis of a result of calibration of the first image and the second image.

3. The image processing device according to claim 1, wherein the calibrator calibrates the first image and the second image when each of the first feature point extractor and the second feature point extractor has extracted a feature point included in the road area successively in a predetermined number of frames or more.

4. The image processing device according to claim 2, wherein the calibrator derives the relative angle on the basis of a normal vector of a road surface of the road area included in the first image and a normal vector of a road surface in the road area included in the second image, converts a coordinate system of the second image to a coordinate system of the first image on the basis of the derived relative angle, and calibrates the first image and the second image.

5. The image processing device according to claim 3, wherein the first feature point extractor extracts a feature point in a first road area in which the mobile object moves and a feature point in a second road area which crosses the first road area as the first feature point from image frames of the first image which are acquired at predetermined time intervals by the acquirer,
wherein the second feature point extractor extracts a feature point in the first road area and a feature point in the second road area as the second feature point from image frames of the second image which are acquired at predetermined time intervals by the acquirer, and
wherein the calibrator calibrates the first image and the second image when the first feature point and the second feature point are extracted from the first image and the second image successively in a predetermined number of frames or more.

6. The image processing device according to claim 1, wherein the road area includes a first road area in which the mobile object moves and a second road area which crosses the first road area.

7. The image processing device according to claim 6, wherein the calibrator calibrates pitch angles of the first imager that captures the first image and the second imager that captures the second image on the basis of the feature point in the first road area, and
wherein the calibrator calibrates roll angles of the first imager and the second imager on the basis of the feature point in the second road area.

8. An image processing method that is performed by a computer, the image processing method comprising:
acquiring a first image obtained by imaging in a first direction of a mobile object and a second image obtained by imaging in a second direction other than the first direction from an imaging device mounted in the mobile object;
extracting feature points from the acquired first image and the acquired second image;
detecting a road area included in the first image;
detecting a road area included in the second image;
extracting a feature point in the detected road area included in the first image out of the extracted feature points as a first feature point;
extracting a feature point in the detected road area included in the second image out of the extracted feature points as a second feature point; and
calibrating the first image and the second image on the basis of the first feature point and the second feature point.

9. A non-transitory computer-readable storage medium that stores a program causing a computer to perform:
acquiring a first image obtained by imaging in a first direction of a mobile object and a second image obtained by imaging in a second direction other than the first direction from an imaging device mounted in the mobile object;
extracting feature points from the acquired first image and the acquired second image;
detecting a road area included in the first image;
detecting a road area included in the second image;
extracting a feature point in the detected road area included in the first image out of the extracted feature points as a first feature point;
extracting a feature point in the detected road area included in the second image out of the extracted feature points as a second feature point; and
calibrating the first image and the second image on the basis of the first feature point and the second feature point.
